(19) United States
(12) Patent Application Publication
(10) Pub. No.: US 2014/0146085 A1
(43) Pub. Date: May 29, 2014

(54) Electronic Equipment, Program, And Control Method

(71) Applicant: Kabushiki Kaisha Toshiba, Tokyo (JP)

(72) Inventor: Kentaro Takeda, Suginami-ku (JP)

(73) Assignee: Kabushiki Kaisha Toshiba, Tokyo (JP)

(21) Appl. No.: 14/030,678

(22) Filed: Sep. 18, 2013

(30) Foreign Application Priority Data
Nov. 29, 2012 (JP) 2012-260837

(51) Int. Cl. G06T 3/00; G06F 3/023

(52) U.S. Cl. CPC G06T 3/0006; G06F 3/023
USPC 345/648; 345/168

(57) ABSTRACT

According to one embodiment, an electronic equipment, includes: a main body of the electronic equipment, an attachment/detachment detecting module, and a controller. The main body of the electronic equipment has a screen to display information and is capable of being inserted into an accommodating module such that a partial region of the screen is accommodated in an accommodating part of the accommodating module. The attachment/detachment detecting module is configured to detect attachment/detachment of the main body of the electronic equipment and the accommodating module. The controller is configured to perform different display controls or function controls in the partial region of the screen which is accommodated in the accommodating module and in a remaining region of the screen which is not accommodated in the accommodating module when the attachment/detachment detecting module detects that the main body of the electronic equipment is inserted into the accommodating module.

### CROSS REFERENCE TO RELATED APPLICATION(S)

The application is based upon and claims the benefit of priority from Japanese Patent Application No. 2012-260837 filed on Nov. 29, 2012; the entire contents of which are incorporated herein by reference.

### FIELD

Embodiments described herein relate to an electronic equipment, a program, and a control method.

### BACKGROUND

Recently, a tablet type electronic equipment which includes a display and a control system and does not include a keyboard is widely used because of good portability.

In such the tablet type electronic equipment, a unit with a keyboard into which a main body of the electronic equipment may be inserted to be connected may be prepared for a user who requires a keyboard manipulation.

In a case of an electronic equipment of the related art, for a structure in which a main body of the electronic equipment is inserted into a unit to be integrated, a part of a display of the main body of the electronic equipment is hidden by the unit. Therefore, when the electronic equipment is used in this state, the hidden area of the display cannot be used, thereby becoming useless.

### BRIEF DESCRIPTION OF THE DRAWINGS

Exemplary embodiments of the present invention will be described in detail based on the following figures, wherein:

FIG. 1 is a view illustrating a configuration of an electronic equipment according to an embodiment;

FIG. 2 is a side view illustrating a state where a main body of the electronic equipment is mounted in a cradle;

FIG. 3 is a view illustrating a configuration of a control system of the electronic equipment according to the embodiment;

FIG. 4 is a flow chart illustrating operations of the electronic equipment according to the embodiment;

FIG. 5 is a view illustrating transition of a screen; and

FIG. 6 is a view illustrating a display example of a state where the main body of the electronic equipment is mounted in the cradle.

### DETAILED DESCRIPTION OF THE EXEMPLARY EMBODIMENTS

An object of the embodiments is to provide an electronic equipment, a program, and a control method which are capable of appropriately using a display panel of a main body of the electronic equipment in a state where a main body of the electronic equipment is mounted in a detachable module.

According to one embodiment, an electronic equipment, includes: a main body of the electronic equipment, an attachment/detachment detecting module, and a controller. The main body of the electronic equipment has a screen to display information and is capable of being inserted into an accommodating module such that a partial region of the screen is accommodated in an accommodating part of the accommodating module. The attachment/detachment detecting module is configured to detect attachment/detachment of the main body of the electronic equipment and the accommodating module. The controller is configured to perform different display controls or function controls in the partial region of the screen which is accommodated in the accommodating module and in a remaining region of the screen which is not accommodated in the accommodating module when the attachment/detachment detecting module detects that the main body of the electronic equipment is inserted into the accommodating module.

Hereinafter, an embodiment will be described in detail with reference to the drawings.

### Embodiment

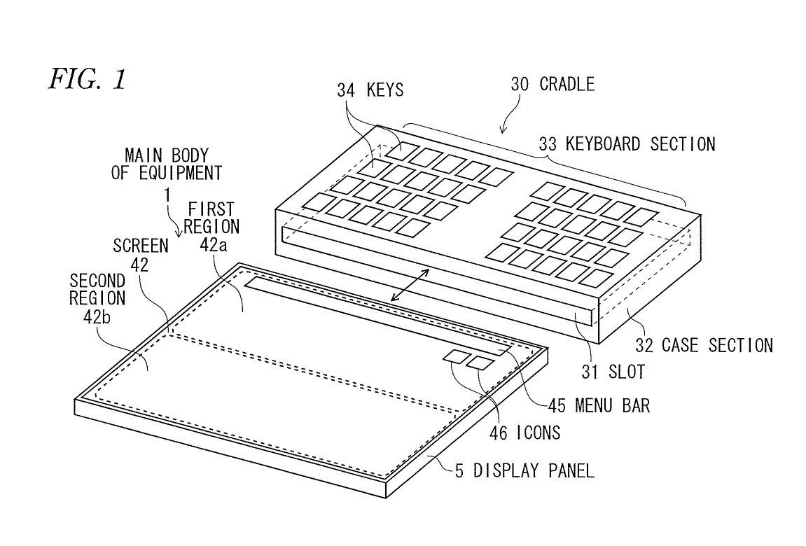

FIG. 1 is a view illustrating a configuration of an electronic equipment according to an embodiment.

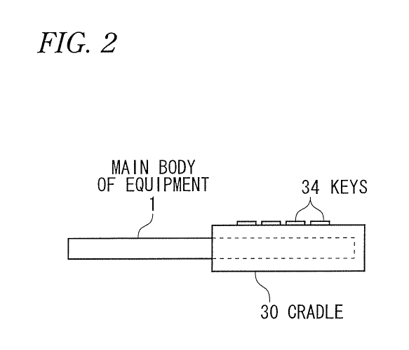

As illustrated in FIGS. 1 and 2, the electronic equipment according to the embodiment includes a main body 1 of the electronic equipment (hereinafter, referred to as a “main body 1 of the equipment”) and a cradle 30 as an accommodating module.

The cradle 30 includes a case section 32 as an accommodating module having a slot 31 into which the main body 1 of the equipment is inserted and a keyboard section 33 as a key operating module which is provided on a surface (top surface) of the case section 32. The cradle 30 may be referred to as, for example, a docking station. Further, the slot 31 may be referred to as, for example, a socket, a dock, or an insertion module.

In the keyboard section 33, keys 34 are arranged in a predetermined arrangement, but characters such as letters or symbols are not imprinted or printed on the keys 34 themselves. All of the case section 32, the keyboard section 33, and the keys 34 are formed of a transparent resin (for example, a plastic resin). For example, a transparent electrode is used as an electric contact of each of the keys 34. Accordingly, a space below the keyboard section 33 may be seen from the above. When the main body 1 of the equipment is inserted, a user may see a screen 42 through the case section 32, the keyboard section 33, and the keys 34.

That is, a wall of the case section 32 in which the main body 1 of the equipment is accommodated is transparent or translucent and the transparent or translucent keys 34 are arranged on the wall of the case section 32 to be opposite to the screen 42 of the main body 1 of the equipment.

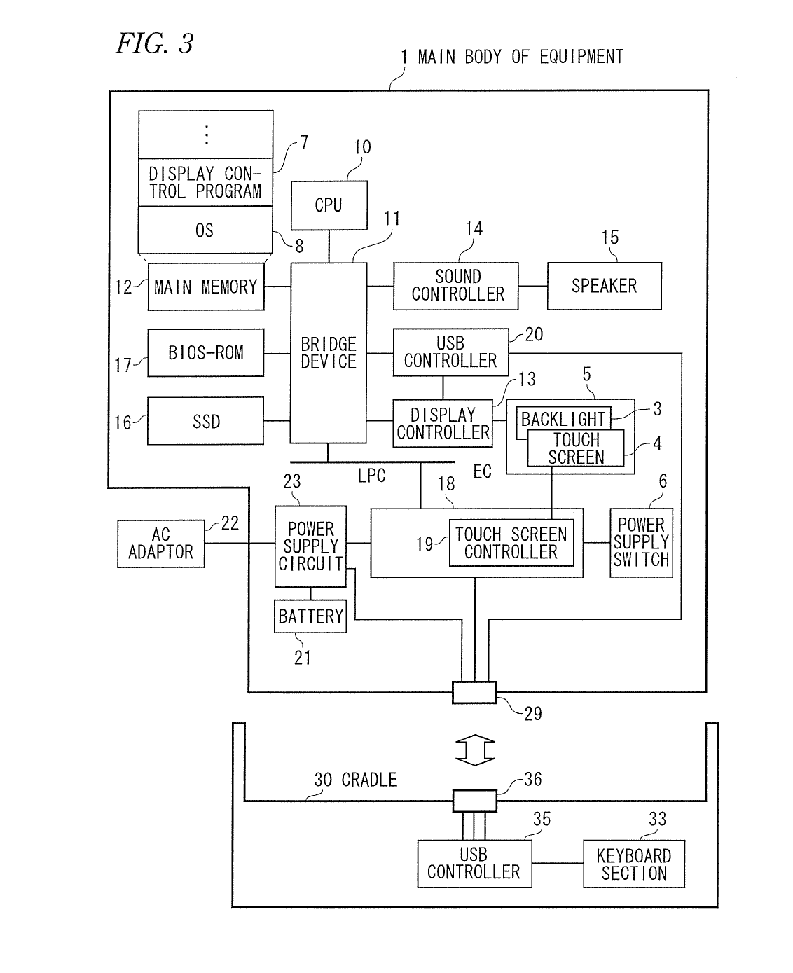

An interface (for example, a USB connector 36 as illustrated in FIG. 3) to connect the main body 1 of the equipment with the keyboard section 33 is provided at the deepest part of the slot 31. The USB is a trademark.

The main body 1 of the equipment is configured to accommodate functions of a computer (for example, a CPU, a memory, or an external interface) in a flat panel type housing and is so-called a tablet type information terminal.

A display panel 5 is provided on a case surface of the main body 1 of the equipment. The screen 42 which displays information is displayed on the display panel 5.

The information includes, for example, a window which is displayed when a started application software performs a processing, in addition to, for example, a menu bar 45, icons 46, and a background image that constitute a desktop screen of an operating system (OS).

The display panel 5 includes a touch screen 4, so that a user may directly touch the screen 42 using a hand or a finger to perform a selection manipulation of the menu bar 45 and the icons 46 which are displayed on the screen 42, an instruction manipulation, and an letter input manipulation.

Meanwhile, when the electronic equipment is implemented on the assumption of a connection with the cradle 30 including the keyboard, the touch screen 4 is not an essential element.

The screen 42 is divided into a first region 42a and a second region 42b whose display control systems are different from each other. The screen 42 is not divided in external appearance. The first region 42a is a partial region of the screen 42 which is accommodated (contained) in the slot 31. The second region 42b is a remaining region which is not accommodated (contained) in the slot 31.

The main body 1 of the equipment may be inserted in the slot 31 of the cradle 30 such that the first region 42a of the display panel 5 is accommodated (contained) in the slot 31.

The control system of the electronic equipment will be described with reference to FIG. 3.

As illustrated in FIG. 3, the electronic equipment includes, for example, a central processing unit (CPU) 10, a bridge device 11, a main memory 12, a display controller 13 as a control module, a sound controller 14, a speaker 15, a solid state drive (SSD) 16, a basic input/output system-read only memory (BIOS-ROM) 17, an embedded controller (EC) 18, and a power supply circuit 23.

The CPU 10 is a processor that controls an operation of each of the components of the main body 1 of the equipment. The CPU 10 executes the operating system (OS) 8 and various utility/application programs which are read from the SSD 16 into the main memory 12.

When a power supply switch 6 is manipulated to start up the electronic equipment and when a BIOS reading command is performed, the CPU 10 reads out the BIOS stored in the BIOS-ROM 17 to execute the BIOS. The BIOS is a program that controls a hardware.

In the present embodiment, one of the various utility/application programs is a display control program 7, and the CPU 10 executes the display control program 7 together with the OS 8. The CPU 10 executes the processing of the display control program 7 to perform a display control operation.

The bridge device 11 has a function that communicates with the display controller 13. The display controller 13 is a controller for a graphic control to control the touch screen 4 which is used as a display of the main body 1 of the equipment.

Further, a memory controller that controls the main memory 12 is also built in the bridge device 11. Further, the bridge device 11 communicates with each of the devices on a low PIN count (LPC) bus.

The OS 8 and the display control program 7 are stored in the SSD 16. The main memory 12 is a temporal storage area which reads the OS 8 and the display control program 7 which are executed by the CPU 10. The CPU 10 reads the OS 8 and the display control program 7 which are stored in the SSD 16 and expands the OS 8 and the display control program 7 in the main memory 12 to control each of the modules.

The display controller 13 performs a display processing (graphic arithmetic processing) to draw display data in a video memory (VRAM) based on a drawing request input from the CPU 10 through the bridge device 11. Display data corresponding to a screen image which is displayed on the touch screen 4 is stored in the video memory.

Further, when a USB controller 20 detects the attachment/detachment of USB connectors 29 and 36, the display controller 13 performs a display control of the screen and a function control of the display function based on the attachment/detachment.

For example, when it is detected that the USB connectors 29 and 36 are connected to each other (the main body 1 of the equipment is inserted in the cradle 30), different display controls are performed in a partial region (first region 42a) of the screen which is accommodated (contained) in the cradle 30 and the remaining region (second region 42b) of the screen which is not accommodated (contained) in the cradle 30, respectively.

Various parameter information concerning a display control is stored in the SSD 16. The parameter information includes a movement amount of the information (for example, icons 46 or menu bar 45) or data concerning an arrangement on the screen of the characters 47 corresponding to the keys 34 of the cradle 30 when the main body 1 of the equipment is mounted on the cradle 30.

The display control program 7 is read in the main memory 12 by the CPU 10 to operate the display controller 13. That is, the display control program 7 performs the display control using the various parameter information based on the detection of the attachment/detachment of the cradle 30. Specifically, the function of the display control program 7 is executed by the operation of the display controller 13.

The embedded controller (EC) 18 has a function that turns ON/OFF a power supply of the main body 1 of the equipment based on the operation of the power supply switch 6 performed by a user. In other words, the embedded controller (EC) 18 controls the power supply circuit 23.

Further, the embedded controller (EC) 18 includes a touch screen controller 19. The touch screen controller 19 controls a touch sensor, which is provided in the touch screen 4, to obtain touch information from the touch sensor and deliver the touch information to the CPU 10 through the bridge device 11. The CPU 10 instructs the display controller 13 to perform the display control based on the touch information.

The USB controller 20 functions as an attachment/detachment detecting module that detects whether the USB connector 29 is connected (attached) to or disconnected (detached) from the USB connector 36 provided in the cradle 30.

The USB controller 20 and the USB connector 36 are connected to each other by a USB cable in which a plurality of signal lines are tied and one of the signal lines is a detect signal line. The USB controller 20 transmits/receives various data and control signals through the USB cable. The embedded controller (EC) 18 operates at all times regardless of whether the electronic equipment is turned ON/OFF.

The display controller 13 controls the light emitting amount of a backlight 3 including turning ON, turning OFF, and reducing the light amount of the backlight 3. The touch screen 4 is configured by, for example, a resistive or capacitive touch sensor or a liquid crystal display (LCD) to detect a touch area or a touch position on the screen.

When an external power supply is supplied through an AC adaptor 22, the power supply circuit 23 generates a system power supply, which is to be supplied to each of the components of the electronic equipment, using the external power supply supplied from the AC adaptor 22.

Further, when an external power is not supplied through the AC adaptor 22, the power supply circuit 23 generates a system power which is to be supplied to each of the components of the main body 1 of the equipment by a power which is charged in a battery 21.

The cradle 30 includes, for example, the keyboard section 33, the USB controller 35, and the USB connector 36.

The keyboard section 33 receives key manipulation by a user to output an instruction command in accordance with the manipulated key to the USB controller 35.

The USB connector 36 is used to be connected with the USB connector 29 provided in the main body 1 of the equipment. When the USB connector 29 and the USB connector 36 are connected to each other, the USB controller 35 is electrically connected to the USB controller 20 of the main body 1 of the equipment through the USB cable.

When the USB connector 36 is connected to the USB connector 29, the USB controller 35 is connected to the power supply circuit 23 of the main body 1 of the equipment, so that the power is supplied from the power supply circuit 23. Therefore, the keyboard section 33 becomes in a usable state.

The USB controller 20 detects the connection/disconnection of the USB connector 29 and the USB connector 36, that is, the attachment/detachment of the main body 1 of the equipment and the cradle 30. Specifically, the USB controller 20 detects that the main body 1 of the equipment is inserted in the slot 31 of the cradle 30 and that the main body 1 of the equipment is separated from the slot 31 of the cradle 30.

When the USB controller 20 detects that the main body 1 of the equipment is inserted into the slot 31 of the cradle 30, the display controller 13 performs different display controls and different function controls in the first region 42a of the screen 42 which is accommodated (contained) in the slot 31 and the remaining second region 42b which is not accommodated (contained) in the slot 31, respectively.

Specifically, the display controller 13 displays, for example, alphanumeric characters and symbols in positions of the first region 42a corresponding to the keys 34 of the keyboard section 33. The background image of this region is an image having a color different from those of the alphanumeric characters and symbols, that is, a color to show off the alphanumeric characters and symbols.

Further, the display controller 13 disposes the information (functional components such as, for example, the icons 46 or the menu bar 45 to start up an application software), which is displayed before inserting the main body 1 of the equipment, at a lower side of the second region 42b to be displayed.

In the meantime, not only the icons 46 or the menu bar 46, but also the entire displayed contents including the background image may be moved. Further, the display controller 13 disables the function of the touch screen 4 in the first region 42a.

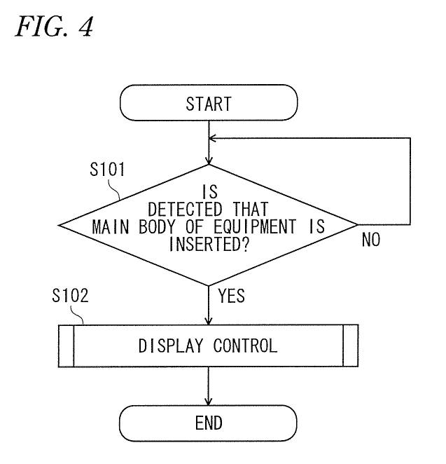

The operations of the electronic equipment according to the present embodiment will be described with reference to FIGS. 4 to 6.

In the present embodiment, the USB controller 20 waits to detect the attachment/detachment of the main body 1 of the equipment and the cradle 30 (step S101).

When a user inserts the main body 1 of the equipment into the cradle 30, the USB controller 20 detects that the main body 1 of the equipment is inserted into the cradle 30 (“Yes” at step S101).

In this case, the display controller 13 performs different display controls in the first region 42a which is accommodated (contained) in the cradle 30 and the second region 42b of the remaining part of the screen which is not accommodated (contained) in the cradle 30 (step S102).

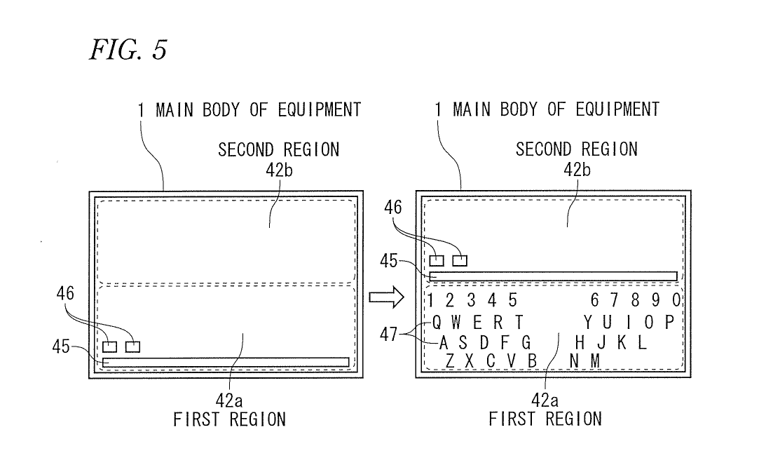

Specifically, as illustrated in FIG. 5, before inserting the main body 1 of the equipment into the cradle 30, assuming that the functional components such as the menu bar 45 or the icons 46 are displayed at the lower part of the first region 42a of the screen 42, the display controller 13 displays the functional components such as the menu bar 45 or the icons 46 to be moved at the lower side of the second region 42b after inserting the main body 1 of the equipment.

Further, the display controller 13 displays the characters 47 for inputting such as alphanumeric characters and symbols in the positions of the first region 42a corresponding to the keys 34 of the keyboard section 33.

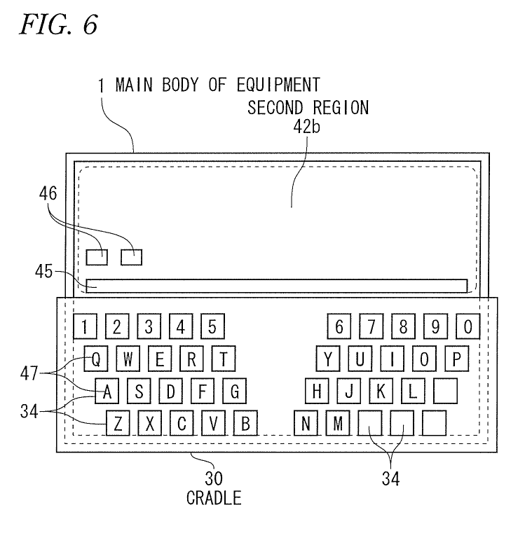

As a result, in a state where the main body 1 of the equipment is inserted into the cradle 30, as illustrated in FIG. 6, the keys 34 may be recognized in a state where the alphanumeric characters and symbols are assigned to the transparent keys 34 of the keyboard section 33, respectively, and a user may perform key inputting manipulation while seeing the alphanumeric characters and symbols transmissively displayed in the positions of the keys 34.

Further, the functional components such as the menu bar 45 or the icons 46 are moved into the second region 42b which is not hidden by the cradle 30 to be displayed, so that a user may manipulate the menu bar 45 or the icons 46 as it is without switching the displayed positions of the functional components.

In other words, when the main body 1 of the equipment is inserted into the cradle 30, a user may smoothly perform a subsequent job without performing the display switching manipulation.

As described above, according to the present embodiment, when the attachment/detachment of the main body 1 of the equipment and the cradle 30 is detected and the insertion of the main body of the equipment into the cradle 30 is detected, different display controls or function controls are performed in the first region 42a which is accommodated (contained) in the cradle 30 and the second region 42b which is not accommodated (contained) in the cradle 30. As a result, for example, the icons 46 or the menu bar 45, which are displayed in the first region 42a, are moved to the second region 42b, and the characters 47 for inputting keys (alphanumeric characters, and symbols) are displayed in the first region 42a. Therefore, a display region which is hidden by the cradle 30 may be used.

As a result, in the state where the main body 1 of the equipment is mounted in the cradle 30, the display panel 5 of the main body 1 of the equipment may be suitably used without waste.

Further, in addition to the display control of the screen 42, the function of the touch screen 4 in the first region 42a is disabled, and for the first region 42a, the light amount of the backlight 3 (light source) in the display panel 5 is controlled to be reduced or the backlight 3 is controlled to be turned OFF to contribute to saving the energy.

In other words, in the state where the main body 1 of the equipment is mounted in the cradle 30, the display contents or a function of the display region of the first region 42a are restricted while displaying a desktop screen in the second region 42b, and thus, the power consumption of the first region 42a is controlled to be reduced.

The embodiment of the present invention has been described, but is for illustrative purposes only and is not intended to limit the scope of the invention. The new embodiment may be variously embodied, and various omissions, substitutions, and changes may be made without departing from the gist of the invention. The embodiment or a modification thereof is included in the scope or gist of the invention and further included in a scope equivalent to that of the invention determined in the following claims.

In the above-described embodiment, even though the cradle 30 which is provided with the keyboard section 33 is described as an example of an accommodating module, the keyboard section 33 is not necessarily provided in the accommodating module, but a cradle only for charging which does not include the keyboard section 33 may be used. When the charging cradle is used as the accommodating module, an AC adaptor 22 and circuits such as a power supply circuit 23 which are provided in the main body 1 of the equipment may also be mounted in the cradle.

Further, in the above-described embodiment, even though the case section 32, the keyboard section 33, and the keys 34 of the cradle 30 are transparent, the case section 32, the keyboard section 33, and the keys 34 may not be transparent if the light amount of the backlight 3 (light source) in the first region 42a of the display panel 5 is controlled to be reduced or the backlight 3 is controlled to be turned OFF when the main body 1 of the equipment is inserted in the cradle 30.

Further, in the above-described embodiment, when the main body 1 of the equipment is inserted into the cradle 30, the icons 46 or the menu bar 45 is moved. However, to improve this configuration, a predetermined application program (document preparation application software such as a text editor) may be started up to display a screen of the program in the second region 42b.

In the above-described embodiment, the alphanumeric characters and symbols are used as examples. However, other language characters or symbols may also be used as long as the other language characters or symbols correspond to the keys 34 of the cradle 30 in number and arrangement.

The components described in the embodiment may be implemented by a program which is installed in a storage of a hard disk device of a computer or the program may be stored in computer readable electronic media and then the computer may read out the program from the electronic media to allow the computer to implement the function of the present invention. The electronic media includes a recording medium such as a CD-ROM, a flash memory or a removable medium. Further, the components may be stored so as to be distributed into different computers which are connected through a network and the components may be implemented by communicating the computers that allow the components to be functioned.

What is claimed is:

1. An electronic equipment, comprising:
a main body of the electronic equipment having a screen to display information and capable of being inserted into an accommodating module such that a partial region of the screen is accommodated in an accommodating part of the accommodating module;
an attachment/detachment detecting module configured to detect attachment/detachment of the main body of the electronic equipment and the accommodating module; and
a controller configured to perform different display controls or function controls in the partial region of the screen which is accommodated in the accommodating module and in a remaining region of the screen which is not accommodated in the accommodating module when the attachment/detachment detecting module detects that the main body of the electronic equipment is inserted into the accommodating module.

2. The electronic equipment of claim 1, wherein the controller moves information, which is displayed in the partial region of the screen before inserting the main body in the accommodating module, into the remaining region of the screen.

3. The electronic equipment of claim 2, wherein the accommodating module is configured such that a surface of the accommodating part into which the main body of the electronic equipment is accommodated is transparent or translucent and transparent or translucent keys are arranged on the surface of the accommodating part so as to be opposite to the screen, and
the controller displays characters for inputting keys in positions of the partial region corresponding to the keys provided in the accommodating module.

4. The electronic equipment of claim 1, wherein the accommodating module is configured such that a surface of the accommodating part into which the main body of the electronic equipment is accommodated is transparent or translucent and transparent or translucent keys are arranged on the surface of the accommodating part so as to be opposite to the screen, and
the controller displays characters for inputting keys in positions of the partial region corresponding to the keys provided in the accommodating module.

5. The electronic equipment of claim 1, wherein the controller controls a light amount of a light source of the partial region of the screen to be reduced or the light source of the partial region to be turned OFF.

6. The electronic equipment of claim 1, wherein when the screen has a touch screen function, the controller disables the function of the touch screen of the partial region of the screen.

7. A program stored in a non-transitory recording medium executed by a computer, which has a screen to display information and is capable of being inserted into an accommodating module so as to accommodate a partial region of the screen in an accommodating part of the accommodating module, comprising:
detect attachment/detachment of the computer and the accommodating module; and
when it is detected that the computer is inserted into the accommodating module, perform different display controls or function controls in the partial region of the screen which is accommodated in the accommodating module and in a remaining region of the screen which is not accommodated in the accommodating module.

8. A control method, comprising:
detecting attachment/detachment of a main body of an electronic equipment, which has a screen to display information and is capable of being inserted into an accommodating module so as to accommodate a partial region of the screen in an accommodating part of the accommodating module, and the accommodating module; and
when it is detected that the main body of the electronic equipment is inserted into the accommodating module, performing different display controls or function controls in the partial region of the screen which is accommodated in the accommodating module and in a remaining region of the screen which is not accommodated in the accommodating module.
